(19) United States
(12) Patent Application Publication
(10) Pub. No.: US 2007/0122693 A1
(43) Pub. Date: May 31, 2007

(54) BATTERY COVER MECHANISM

(75) Inventors: Zhong-Shu Qin, Shenzhen (CN); Ye Liu, Shenzhen (CN); Gang Yin, Shenzhen (CN); Hsiao-Hua Tu, Tu-Cheng (TW); Chia-Hua Chen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO.,LTD., Shindian (TW)

(21) Appl. No.: 11/309,362

(22) Filed: Aug. 1, 2006

(30) Foreign Application Priority Data
Nov. 25, 2005 (CN) 200510101774.4

(51) Int. Cl. H01M 2/10

(52) U.S. Cl. 429/97; 429/100

(57) ABSTRACT

A battery cover mechanism comprises a battery cover (10), a housing (20) and a hinge mechanism (30). The battery cover has an installing side (101) and a movable side (102) opposite to the installing side. The housing includes a first surface (201) and a second surface (202) that is opposite to the first surface, and the housing defining a receiving chamber (21) in the first surface. The hinge mechanism rotatably mounts the installing side to the housing, and the cover is rotatable to cover or uncover the receiving chamber.

### FIELD OF THE INVENTION

The present invention relates to a battery cover mechanism used in a portable electronic device such as a mobile phone, a personal digital assistant (PDA), a laptop, and so on.

### DESCRIPTION OF RELATED ART

Attachable batteries are widely used in portable electronic devices such as mobile telephones and PDAs (personal digital assistants) to supply power. During use, a battery is contained in a housing of a portable electronic device and covered by an attachable cover, the cover cooperates with the housing to secure and protect the battery.

The cover is usually not connected with the housing but attached to the housing via some connecting mechanisms such as latching protrusions and latching grooves formed on the cover and the housing. Generally, the cover can be separated from the housing for replacing the battery more conveniently. However, the cover being separated from the housing is prone to be damaged or be lost when replacing the battery.

What is needed, therefore, is a battery cover mechanism that can prevent the cover from being separated from the housing of the portable electronic device to overcome above-described problems.

### SUMMARY OF THE INVENTION

In a preferred embodiment, a battery cover mechanism comprises a battery cover, a housing and a hinge mechanism. The battery cover has an installing side and a movable side opposite to the installing side. The housing includes a first surface and a second surface that is opposite to the first surface, and the housing defining a receiving chamber in the first surface. The hinge mechanism rotatably mounts the installing side to the housing, and the cover is rotatable to cover or uncover the receiving chamber.

Other advantages and novel features will become more apparent from the following detailed description when taken in conjunction with the accompanying drawings.

### BRIEF DESCRIPTION OF THE DRAWINGS

Many aspects of the battery cover mechanism can be better understood with reference to the following drawings. The components in the drawings are not necessarily drawn to scale, the emphasis instead being placed upon clearly illustrating the principles of the present portable electronic device. Moreover, in the drawings, like reference numerals designate corresponding parts through-out the several views.

FIG. 1 is an exploded, isometric view along a first direction of a battery cover mechanism in accordance with a preferred embodiment of the present invention;

FIG. 2 is similar to FIG. 1, but showing a second direction of the battery cover mechanism illustrated in FIG. 1;

FIG. 3 is an assembled view along the first direction of the battery cover mechanism with a closed battery cover;

FIG. 4 is an assembled view along the second direction of the battery cover mechanism with a closed battery cover;

FIG. 5 is an assembled view along the second direction of the battery cover mechanism with an open battery cover; and

FIG. 6 is a cut-away view of the battery cover mechanism.

### DETAILED DESCRIPTION OF THE INVENTION

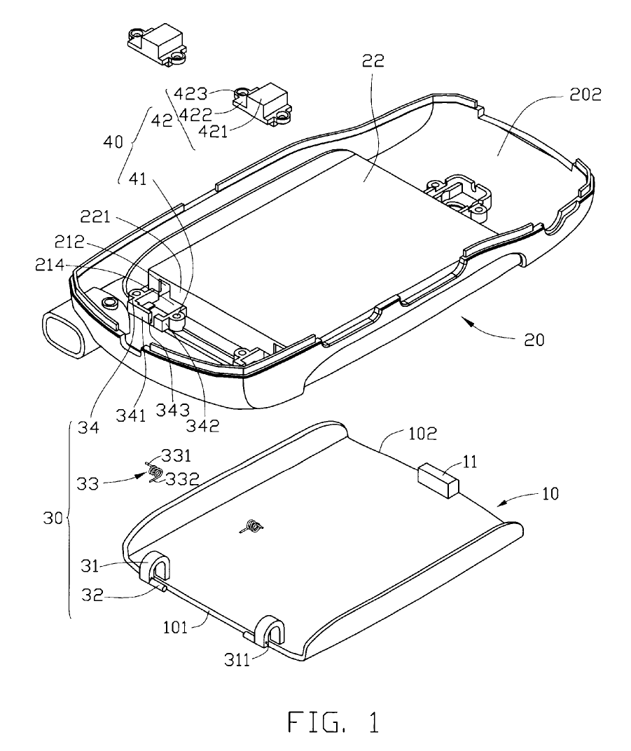

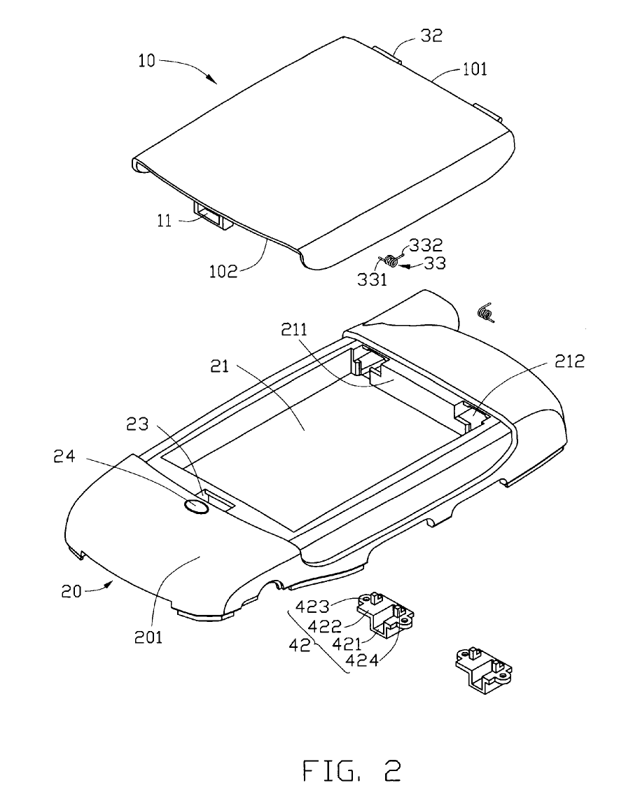

Referring now to the drawings, FIG. 1 and FIG. 2 show a battery cover mechanism according to a preferred embodiment of the present invention. The battery cover mechanism is used in a portable electronic device such as a mobile phone, a PDA or a laptop, etc. The battery cover mechanism includes a battery cover 10, a housing 20, a hinge mechanism 30 and a confining mechanism 40. The cover 10 is rotatably installed on the housing 20 via the hinge mechanism 30. The confining mechanism 40 prevents the hinge mechanism 30 from separating from the housing 20.

The battery cover 10 is approximately a rectangular board. The battery cover 10 includes an installing side 101, a movable side 102 and a latch 11. The movable side 102 is opposite to the installing side 101. The latch 11 is a protrusion formed adjacent to the movable side 102.

The housing 20 is a part of the portable electronic device. The housing 20 is a board that includes a first surface 201, a second surface 202, a receiving chamber 21, a latching hole 23 and a button 24. The first surface 201 is positioned opposite to the second surface 202. The housing 20 defines the receiving chamber 21 in the first surface 201 for receiving a battery (not shown) of the portable electronic device. The battery cover 10 rotatably covers the receiving chamber 21. A side-wall 211 is formed surrounding the receiving chamber 21, and the housing 20 defines two through holes 212 through the sidewall 211. The housing 20 also defines two spaced receiving holes 214 extending through the first surface 201 and the second surface 202. Each through hole 212 communicates with a respective receiving hole 214. A convex stage 22 positioned corresponding to the receiving chamber 21 is formed on the second surface 202, and the two through holes 212 and the two receiving holes 214 run through the convex stage 22. The housing 20 defines the latching hole 23 in the first surface 201 and adjacent to the receiving chamber 21. When the battery cover 10 is closed, the latch 11 is inserted into the latching hole 23. A spring clip (not shown) is installed in the latching hole 23. When the latch 11 is inserted into the latching hole 23, the spring clip secures the latch 11 automatically. The button 24 is installed on the first surface 201 and located adjacent to the latching hole 23. The spring clip is connected with the button 24. When the button 24 is pressed, the spring clip is released. Additionally, some electrical contacts (not shown) for the battery can be installed on the housing 20.

The hinge mechanism 30 includes two hooks 31, two axles 32, two torsion springs 33 and two installing portions 34. The hooks 31 are two parallel protrusions formed on the installing side 101 of the battery cover 10. The hooks 31 extend perpendicularly to the battery cover 10 and an end of each hook 31 forms a bent portion (not labeled), thus each hook 31 has a shape similar to the letter “U”. The axles 32 consist of two columns, each axle 32 is formed on an individual side of a hook 31. The axles 32 are orientated parallel to the battery cover 10 and perpendicular to the hooks 31. Each hook 31 defines an inserting hole 311 adjacent and parallel to one of the axles 32. The torsion springs 33 are two columnar springs, each torsion spring 33 includes an inserting end 331 and a radial end 332. The inserting end 331 extends along a direction parallel to the axles of the torsion spring 33. The radial end 332 extends along a radial direction of the torsion spring 33 and corresponding in direction and shape to the inserting hole 311 of the hook 31. Each installing portion 34 consists of a frame formed by a group of protrusions formed on the second surface 202 and respectively adjacent to a through hole 212 through the convex stage 22. Each installing portion 34 includes a retaining wall 341 and two connecting walls 342 perpendicular to the retaining wall 341. Each retaining wall 341 is located opposite to a through hole 212, and each retaining wall 341 defines a gap 343 therein. Each connecting wall 342 is located beside a through hole 212.

The confining mechanism 40 includes a plurality of retaining holes 41 and two retaining covers 42. The housing 20 defines the retaining holes 41 in the second surface 202 and adjacent to the installing portions 34. Screw thread (not shown) is formed in an inner surface of each retaining hole 41. Each retaining cover 42 includes a receiving portion 421, a plurality of retaining portions 422, a plurality of mounting holes 423 and two resisting portions 424. The receiving portion 421 is a rectangular shield, and the retaining portions 422 are boards extending from the receiving portion 421. Each retaining portion 422 defines the mounting hole 423 running through the retaining portion 422, and each mounting hole 423 is positioned corresponding to one of the retaining holes 41. Screw thread (not shown) is formed in an inner surface of each mounting hole 423. The resisting portions 424 are protrusions formed on the retaining portions 422, and the resisting portions 424 are positioned opposite to the receiving portion 421.

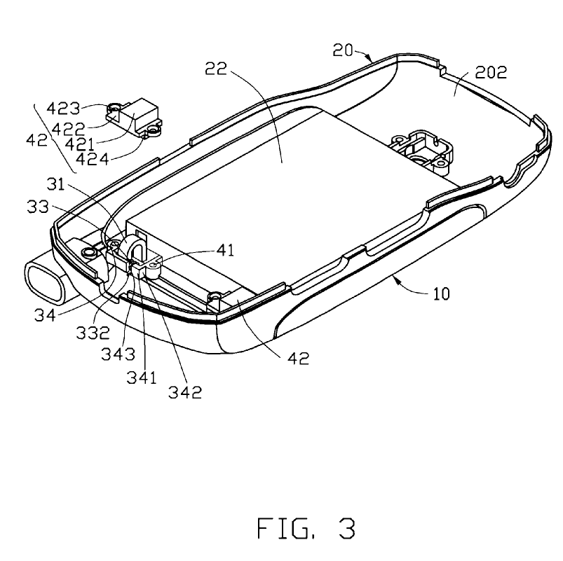

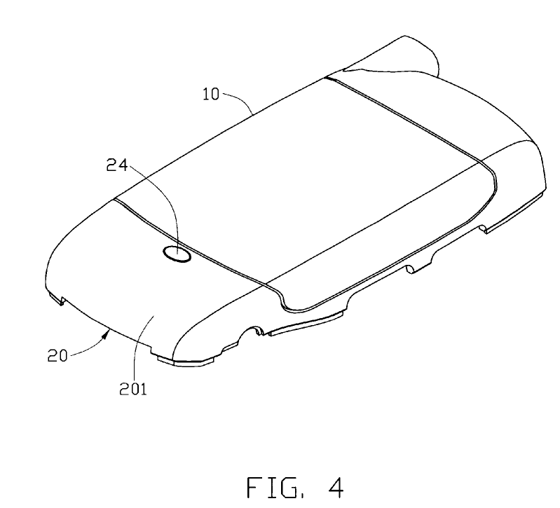

Referring to FIG. 3 and FIG. 4, in use, firstly, the torsion springs 33 are coiled around the axles 32 respectively, each inserting end 331 is inserted into an inserting hole 311 respectively, and the torsion springs 33 are retained on the axles 32. Secondly, the battery cover 10 is located adjacent to the first surface 201 of the housing 20, each hook 31 and each axle 32 of the battery cover 10 is received in a receiving hole 214 of the housing 20, with the hook 31 aligning with a through hole 212 and the elastic ends 332 locked in the gaps 343, thus the installing side 101 of the battery cover 10 is rotatably clasped on the first surface 201.

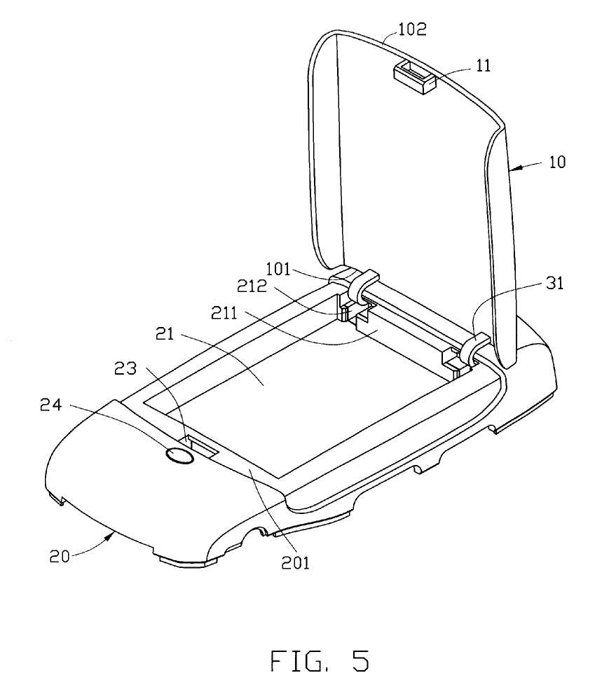

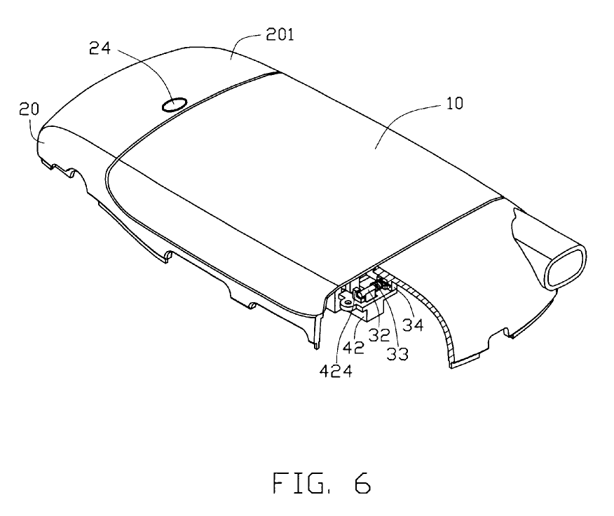

Referring to FIG. 5 and FIG. 6, thirdly, each retaining cover 42 is mounted on the second surface 202 of the housing 20 and aligned with the installing portion 34. The axles 32 are blocked in the installing portions 34 by the resisting portions 424. Each mounting hole 423 is aligned with one corresponding retaining hole 41, some bolts (not shown) are used to cooperate with the screw thread of the retaining holes 41 and the mounting hole 423 to connect the retaining covers 42 to housing 20. In this way, each hook 31 is received in a respective receiving portion 421. The retaining covers 42 cooperate with the installing portions 34 to prevent the hooks 31 and the axles 32 popping out from the installing portions 34, thus preventing the battery cover 10 separating from the housing 20. On the other hand, the axles 32 is rotatably received in the axle holes, thus the hooks 31 can rotate in the receiving hole 214, in this way the battery cover 10 can rotate around the axles 32, and the battery cover 10 is thus rotatably installed on the housing 20.

Finally, the battery is received in the receiving chamber 21. When the battery cover 10 is closed, the latch 11 engages in the latching hole 23 and secured by the spring clip in the latching hole 23, thus the battery cover 10 is secured. In this way, the battery is secured to connect with the electrical contacts and supply power to the portable electronic device. At the same time, the hooks 31 and the axles 32 are driven to rotate by the battery cover 10, the torsion springs 33 is twisted and produces a predetermined elastic force.

Also referring back to FIG. 4, FIG. 5 and FIG. 6, when the battery needs to be replaced, the button 24 is pressed and the spring clip is released. The elastic force twisted in the torsion springs 33 is thus released, and the axles 32 and the hooks 31 are driven to rotate by the torsions springs 33, the battery cover 10 is driven to rotate with the axles 32 and open. When the battery cover 10 rotates to a predetermined angle, the axles 32 are blocked by the resisting portions 424, and the battery cover 10 is then remains opened to the predetermined angle. In this way, when the battery is being replaced, the hinge mechanism 30 and the battery cover 10 cannot separate from the housing 20. After replacing the battery, the battery cover 10 is pressed to close, the latch 11 is inserted into the latching hole 23, the spring clip secures the latch 11, the mobile phone may then be used.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover mechanism, comprising:
a battery cover having an installing side and a movable side opposite to the installing side;
a housing including a first surface and a second surface that is opposite to the first surface, the housing defining a receiving chamber in the first surface; and
a hinge mechanism rotatably mounting the installing side to the housing, the cover being rotatable to cover and open the receiving chamber.

2. The battery cover mechanism as claimed in claim 1, further including a confining mechanism that prevents the hinge mechanism from becoming separated from the housing.

3. The battery cover mechanism as claimed in claim 2, wherein a side-wall is formed surrounding the receiving chamber, the housing defines two through holes through the side-wall, and the housing defines two receiving holes extending through the first surface and the second surface; each through hole communicates with a respective receiving hole, a convex stage corresponding to the receiving chamber is formed on the second surface, the two through holes and the two receiving holes run through the convex stage.

4. The battery cover mechanism as claimed in claim 1, wherein the hinge mechanism includes a pair of axles around which the battery cover rotates, and a pair of torsion springs each attached around to a respective one of the axles, each of the torsion springs has two spring ends, one of the spring ends engages with the battery cover, the other of the spring ends engages with the housing.

5. The battery cover mechanism as claimed in claim 4, wherein the battery cover includes a pair of hooks formed on the installing side thereof, and the axles each extend from a respective one of the hooks.

6. The battery cover mechanism as claimed in claim 5, wherein the hooks have a shape similar to the letter “U”.

7. The battery cover mechanism as claimed in claim 3, wherein the hinge mechanism includes two installing portions that each includes a frame formed by a group of protrusions formed on the second surface adjacent to the through holes.

8. The battery cover mechanism as claimed in claim 7, wherein each installing portion includes a retaining wall and two connecting walls, and each retaining wall defines a gap therein.

9. The battery cover mechanism as claimed in claim 8, wherein the confining mechanism includes a plurality of retaining holes, the retaining holes are defined in the second surface and adjacent to the installing portions.

10. The battery cover mechanism as claimed in claim 7, wherein the confining mechanism includes two retaining covers, the retaining covers cooperate with the installing portions to prevent the battery cover separating from the housing.

11. The battery cover mechanism as claimed in claim 10, wherein each retaining cover includes a receiving portion, a plurality of retaining portions and a plurality of resisting portions; the retaining portions are extending from the receiving portion, the resisting portions are formed on the retaining portions, and the resisting portions are positioned opposite to the receiving portion.

12. The battery cover mechanism as claimed in claim 11, wherein each retaining portion defines a mounting hole through the retaining portion and each mounting hole is positioned corresponding to one of the retaining holes; screw thread is formed in inner surfaces of the mounting holes; the retaining covers are connected to the housing via the retaining holes and the mounting holes connected by bolts.

13. The battery cover mechanism as claimed in claim 1, wherein the battery includes a latch formed adjacent to the movable side; the housing defines a latching hole in the first surface, a spring clip is installed in the latching hole, the latch cooperates with the spring clip to secure the battery cover; the housing includes a button installed on the first surface, the spring clip is connected with the button.

14. A portable electronic device, comprising:
a housing having a battery receiving portion;
a battery cover rotatably mounted to one side of the receiving portion; and
a confining mechanism mounted to said one side of the receiving portion and configured for preventing the battery cover from becoming separated from the housing.

15. The portable electronic device as claimed in claim 14, wherein the confining mechanism includes two retaining covers, the retaining covers cooperate with the installing portions to prevent the battery cover separating from the housing.

16. The portable electronic device as claimed in claim 15, wherein each retaining cover includes a receiving portion, a plurality of retaining portions and a plurality of resisting portions; the retaining portions are extending from the receiving portion, the resisting portions are formed on the retaining portions, and the resisting portions are positioned opposite to the receiving portion.

17. The portable electronic device as claimed in claim 16, wherein the housing defines a plurality of retaining holes, each retaining portion defines a mounting hole through the retaining portion and each mounting hole is positioned corresponding to one of the retaining holes; the retaining covers are connected to the housing via locking members engaging in the retaining holes and the mounting holes.

18. A housing assembly for an electronic device, the housing assembly comprising:
a housing having a battery receiving portion;
a battery cover having first and second opposite cover sides, the first cover side being connected to the housing in a manner so as to be rotatable between a covering position for covering the battery receiving portion and an opened position for opening the battery receiving portion, the second cover side including a locking portion configured for locking the second cover side to the housing when the battery cover is in the covering position; and
a resilient member mounted between the batter cover and the housing and configured for biasing the battery cover toward the opened position.

19. The housing assembly as claimed in claim 18, wherein the battery cover includes a hook formed on the first cover side, an end of the hook forms a bent portion, thus the hook has a shape similar to the letter “U”.

20. The housing assembly as claimed in claim 19, wherein the battery cover includes a axle each extending from the hook, and the resilient member includes a torsion spring attached around the axle, the torsion spring includes a first spring end and a second spring end; the first spring end is inserted into an inserting hole defined in the hook, and the second spring end engages the housing.
